(19) United States
(12) Patent Application Publication
(10) Pub. No.: US 2015/0316425 A1
(43) Pub. Date: Nov. 5, 2015

(54) PUMP PROVIDED WITH AN ASSEMBLY FOR MEASURING THE TEMPERATURE OR FLOW RATE OF A FLUID

(71) Applicants: COMMISSARIAT Á L'ÉNERGIE ATOMIQUE ET AUX ÉNERGIES ALTERNATIVES, Paris (FR); EVEON, Montbonnot Saint Martin (FR)

(72) Inventor: Stephane Nicolas, Meylan (FR)

(21) Appl. No.: 14/651,707

(22) PCT Filed: Dec. 11, 2013
(86) PCT No.: PCT/EP2013/076282

§ 371 Date: Jun. 12, 2015

(30) Foreign Application Priority Data
Dec. 14, 2012 (FR) 1262050

(51) Int. Cl. G01K 13/02; G01F 1/05; F04B 53/16; F04B 43/02; F04B 53/10

(52) U.S. Cl. CPC G01K 13/02; F04B 43/02; F04B 53/10; F04B 53/16; G01F 1/05; F05C 2203/02; F05C 2203/06; F05C 2203/08; F05C 2251/04

(57) ABSTRACT

A pump including a first substrate in a plane with a side having a cavity formed therein. There are intake and discharge channels in the side for admitting and discharging a fluid. There is a second substrate having a side joined to the first substrate, to close the channels and form tubes in which pumped fluid flows. The second substrate also has a membrane to close the cavity to form a leak-tight chamber. The membrane is deformable: in order to expel the fluid out of the chamber via the discharge channel, and to suck the fluid into the chamber via the intake channel. There is actuator capable of converting the energy into movement of the membrane and an assembly for measuring the temperature/flow rate of the fluid. There is a temperature probe placed on the exterior side of the insulating material to insulate thermally the probe from the substrate.

### RELATED APPLICATIONS

This application is a U.S. National Stage of International Application Number PCT/EP2013/076282, filed Dec. 11, 2013, which claims the benefit of the priority date of French Patent Application FR 1262050, filed Dec. 14, 2012, the contents of which are herein incorporated by reference.

### FIELD OF INVENTION

One subject of the invention is a pump incorporating an assembly for measuring the temperature or flow rate of a fluid. Another subject of the invention is a process for fabricating this pump. The invention especially relates to microassemblies and micropumps, which are microsystems.

### BACKGROUND

MEMS (micro-electromechanical systems) are one example of microsystems. These microsystems differ from macroscopic mechanical systems in their fabrication process, inter alia. These microsystems are produced using the same wafer-scale fabrication processes as those used to produce microelectronic chips. For example, microsystems are produced from wafers of single-crystal silicon that are machined by photolithography and etching (for example deep reactive ion etching (DRIE etching)) and/or structured by epitaxial growth and deposition of metal.

By virtue of these fabrication processes, microsystems are small and generally comprise machined parts or part components with at least one micron-sized dimension. The micron-sized dimension is generally smaller than 200 μm in size and, for example, comprised between 1 and 200 μm in size.

Known pumps comprise:
a first substrate extending essentially in a plane, this substrate having a side;
a cavity formed in the side of the first substrate;
intake and discharge channels for admitting and discharging a fluid, respectively, which channels are formed in the side of the first substrate; and
a second substrate having a side joined to the side of the first substrate, this side closing the channels in order to form tubes inside of which the pumped fluid is able to flow, this second substrate also comprising at least one membrane closing the cavity to form a chamber that is leak-tight to the fluid, this membrane being deformable:
   from a suction position to an expulsion position in order to expel the fluid out of the chamber via the discharge channel, and
   from the expulsion position to the suction position in order to suck the fluid into the chamber via the intake channel.

Such a known pump is described in patent application WO 2011/133014.

Prior art is also known from:
U.S. Pat. No. 6,527,835 B1;
WO 02/42723 A1;
U.S. Pat. No. 7,255,001 B1; and
DE 10 161 202 C1.

It is necessary to measure with precision the temperature or flow rate of the pumped fluid.

### SUMMARY OF INVENTION

The invention aims to provide such a pump equipped with an assembly for measuring the temperature or flow rate of the pumped fluid while nevertheless not complexifying fabrication of this pump. One of its subjects is therefore a pump as claimed in claim 1.

The measuring assembly incorporated in the above pump allows the pump to be fabricated by machining and joining just two substrates. The above pump therefore remains simple to fabricate even though it incorporates an assembly for measuring the temperature or flow rate of the pumped fluid.

In addition, use of a thermally insulating material housed in a well inside the substrate, and on which the temperature probe is placed, allows the temperature probe to be thermally insulated from the substrate without recourse to a movable membrane suspended above an empty cavity. The measuring assembly thus obtained is therefore more precise than known measuring assemblies because the cross section of the tube or of the chamber through which the fluid passes does not vary above the temperature probe.

Lastly, the above assembly remains simple to produce using the wafer-scale fabrication processes conventionally used to produce microelectronic chips. In particular, this assembly makes it possible to use substrates that are easily machinable and joinable and that are widely used in microelectronics, such as silicon substrates, even if these substrates have a very good thermal conductivity. Moreover, given that the exterior side of the well is flush with that of the substrate, it is simple to connect electrically the temperature probe to other elements produced on the same substrate as there is no height difference to overcome between the temperature probe located on the exterior side of the well and other elements located directly on the substrate.

Embodiments of this pump may comprise one or more of the features of the dependent claims.

These embodiments of the pump furthermore have the following advantages:
the fact that the substrate encircles the well makes it possible to limit the number of substrates used to fabricate the assembly and to make it easier to join the substrates together; and
making the thickness of the thermally insulating material of the well larger than 100 μm makes it possible to obtain a very good thermal insulation of the temperature probe and therefore a very precise measuring assembly.

Another subject of the invention is a process for fabricating a pump as claimed in claim 9.

Embodiments of this fabrication process may comprise one or more of the features of the dependent claims.

These embodiments of the process furthermore have the following advantages:
using a sheet of thermally insulating material and then applying a heat treatment so that this sheet melts into the well makes it very easy to fabricate wells filled with thermally insulating materials such as glass; and
producing, in a single step, a well filled with oxidizable material and then oxidizing this material allows the well filled with thermally insulating material to be obtained without recourse to a step consisting in digging a well in the side of the substrate.

The invention will be better understood on reading the following description, which is given merely by way of nonlimiting example and with reference to the appended drawings.

### BRIEF DESCRIPTION OF THE DRAWINGS

FIG. 1 is a schematic illustration of a pump in vertical cross section;

FIG. 2 is a schematic illustration of a top view of a first substrate of the pump in FIG. 1;

FIG. 3 is an illustration in vertical cross section of an assembly for measuring the pump flow rate, incorporated into the pump in FIG. 1;

FIG. 4 is a flowchart of a process for fabricating the pump in FIG. 1;

FIGS. 5 to 17 are schematic illustrations, in vertical cross section, of various steps for fabricating the pump in FIG. 1;

FIG. 9A is a schematic illustration, in vertical cross section, of a variant of the fabrication step in FIG. 9;

FIGS. 18, 23 and 27 are flowcharts of various processes for fabricating the assembly in FIG. 3;

FIGS. 19 to 22 are schematic illustrations, in vertical cross section, of the various steps of the process in FIG. 18;

FIGS. 24 to 26 are schematic illustrations, in vertical cross section, of the various steps of the process in FIG. 23;

FIGS. 28 to 30 are schematic illustrations, in vertical cross section, of the various steps of the process in FIG. 27; and

FIG. 31 is a schematic illustration, in vertical cross section, of another embodiment of the pump in FIG. 1.

In these figures, the same references are used to designate the same elements.

### DETAILED DESCRIPTION

In the rest of this description, features and functions that are well known to those skilled in the art are not described in detail.

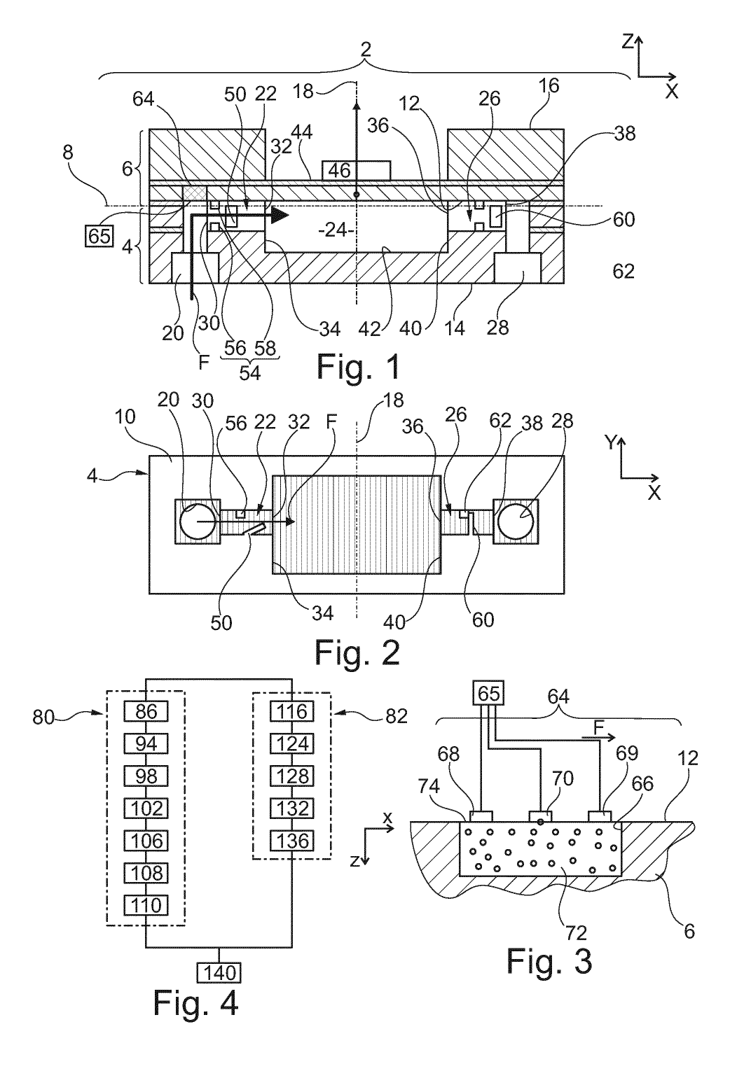

FIG. 1 shows a planar pump 2, i.e. the main elements of the pump are located in a given plane parallel to one side of a given substrate. This pump 2 is designed to allow a very precise volume of a fluid to be pumped. The fluid may be a liquid such as water or a solution to be injected. The fluid may also be a gas. The flow direction of the fluid inside the pump is indicated by an arrow F. In the rest of the description, upstream and downstream are defined relative to the flow direction F.

Here, the pump 2 is a microsystem and may therefore be called a micropump. Typically, the largest width of the pump is smaller than 2 or 1 cm. This largest width is generally larger than 1 mm.

Here, the pump 2 is produced from only two substrates 4 and 6, which are bonded one on top of the other. The bonding interface 8 between these two substrates 4 and 6 is shown by an axis in FIG. 1. This bonding interface 8 extends in a horizontal plane parallel to the X and Y directions, which are orthogonal to each other. A Z direction orthogonal to the X and Y directions shows the vertical direction. Below, the terms “upper”, “lower”, “above” and “below” are defined relative to this Z direction.

The substrate 6 is above the substrate 4. The substrate 4 comprises:
a horizontal upper side 10 (FIG. 2) turned toward a horizontal lower side 12 of the substrate 6; and
a horizontal lower side 14 opposite the side 10.

The substrate 6 also comprises a horizontal upper side 16 opposite its lower side 12.

The various layers forming each of these substrates will be described in more detail with reference to the process in FIG. 3. FIG. 2 shows a top view of the pump 2 when the substrate 6 is omitted.

The following description of the pump 2 is given with reference to these two figures, FIGS. 1 and 2.

The pump 2 contains a vertical cross-sectional plane 18. Here, this plane 18 is parallel to the Y and Z directions. Below, only the elements of the pump 2 in the left-hand portion of this plane 18 will be described in detail.

The substrate 4 comprises in succession in the flow direction F of the fluid:
a vertical through-hole 20 passing right through the substrate 4;
a rectilinear intake channel 22 for admitting the fluid;
a leak-tight chamber 24;
a rectilinear discharge channel 26 for discharging the fluid; and
another vertical through-hole 20 passing right through the substrate 4.

One end of the hole 20 opens onto the lower side 14. Here, this end is flared in order to receive, for example, a sleeved tube allowing the pump 2 to be connected to the outlet of a fluidic circuit.

The opposite end of the hole 20 opens onto the upper side 10. This end is blocked by the lower side 12 of the substrate 6.

The hole 28 is the symmetric of the hole 20 with respect to the plane 18.

The channel 22 extends horizontally parallel to the X direction. It extends from an inlet orifice 30 as far as an outlet orifice 32. The orifice 30 opens onto a vertical wall of the hole 20. The orifice 32 opens onto a vertical wall 34 of the chamber 24.

The cross section of the channel 22 is for example rectangular. The upper wall of the channel 22 is here formed by the lower side 12 of the substrate 6. The channel 22 therefore forms a tube.

The channel 26 is the symmetric of the channel 22 with respect to the plane 18. It extends from an inlet orifice 36 as far as an outlet orifice 38. The orifices 36 and 38 open onto a vertical wall 40 of the chamber 24 and onto the hole 28, respectively. The wall 40 is the symmetric of the wall 34 with respect to the plane 18.

The chamber 24 extends on either side of the plane 18. Here, this chamber 24 is a parallelepiped that mainly extends horizontally. The chamber 24 defines a hollow space formed by bringing together:
a cavity dug into the upper side 10 of the substrate 4; and
a movable membrane 44 produced in the substrate 6.

The cavity is bounded in the substrate 4 by a vertical walls, especially including the walls 34 and 40, and by a horizontal wall 42 also called the bottom of the cavity.

The vertical walls and the bottom of the cavity are integrally formed with the substrate 4 and are unable to move.

The aperture of this cavity opens onto the upper side 10.

Here, the interior of the chamber 24 is empty, i.e. especially devoid of anti-return valve.

The membrane 44 covers the entirety of the aperture of the cavity in order to form the leak-tight chamber 24. The chamber 24 is leak-tight to the pumped fluid.

The membrane 44 deforms elastically between a suction position and an expulsion position. When it moves from the expulsion position to its suction position, it sucks fluid into the chamber 24 via the channel 22. When it moves from its suction position to its expulsion position, it expels fluid from the interior of the chamber 24 toward the exterior via the channel 26.

In FIG. 1, the membrane 44 is shown in a rest position. In this rest position it extends horizontally.

In this embodiment, in the suction position, the membrane 44 is deflected into the interior of the substrate 6. In this position, the apex of the membrane 44 is retracted inside the substrate 6 relative to its location in the rest position of the membrane.

In the expulsion position, the membrane 44 is deflected into the interior of the cavity formed in the substrate 4. The apex of the membrane 44 is then located inside the cavity of the substrate 4. This movement of the membrane on either side of its rest position allows the volume pumped to be maximized and therefore the capacity of the pump to be increased.

Here, the membrane 44 is integrally formed with the substrate 6. Its periphery is therefore secured with no degree of freedom to the rest of the substrate 6.

The pump 2 also comprises an actuator 46 capable of converting the energy that it receives into a movement of the membrane 4 between its suction and expulsion positions. For example, the actuator 46 is a conventional actuator such as an electrostatic actuator or a piezoelectric actuator or a bimetallic actuator, such as a bimetallic strip, or a shape memory actuator or a thermo-pneumatic actuator or an electromagnetic actuator.

In certain cases, the actuator is completely or partially merged with the membrane 44. This is the case when the membrane 44 is made of a piezoelectric material or by a bilayer complex in which each layer has a different expansion coefficient from the other in order to form a bimetallic strip. The energy received by the actuator may be electrical energy or thermal energy. Thermal energy is for example used when the actuator comprises a bimetallic complex. Of course, the actuator according to the invention may also be a device external to the membrane and connected to the latter by a mechanical linking element.

The channel 22 comprises an anti-return valve 50 able to prevent or limit the flow of the fluid in the direction opposite to the direction F. This valve 50 is located upstream of the orifice 32 and downstream of the orifice 30 inside the channel 22. It is movable between an open position and a closed position. In the open position, it allows fluid to flow more easily in the direction F than in its closed position. In its closed position, it prevents the fluid from flowing in the opposite direction to the direction F. Here, in its closed position, the valve 50 extends parallel to the plane 18. In its open position, shown in FIGS. 1 and 2, the valve 50 is inclined downstream.

The valve 50 is a flexible tongue with the same cross section as the cross section of the channel 22 but slightly smaller in size. Here, the valve 50 therefore has a rectangular cross section. The height of this valve h_{c} in the Z direction and its width L_{c} in the Y direction are smaller, for example by at least 0.1 μm or 1 μm, respectively, than the height and width of the channel 22 in the same directions.

The valve 50 moves between its open and closed positions via rotation about an axis secured to the substrate 4. Specifically, a proximal side of the valve 50 is anchored with no degree of freedom to one of the walls of the channel 22. Here, this proximal side is anchored to a vertical wall of the channel 22. Thus, the valve 50 is integrally formed with the substrate 4.

The valve 50 is flexible in order to be able to deform elastically between its open and closed positions under the action of the flowing fluid alone. For this purpose, the thickness e_{c} of the valve 50 is at least five or ten times smaller than its width L_{c} or its height h_{c}. Typically, the width L_{c} and height h_{c} are larger than 50 or 100 μm. Therefore, typically, the thickness of the valve 50 is smaller than 10 μm or 5 μm.

In its rest position, i.e. in the absence of a difference in the pressure upstream and downstream of the valve 50, the latter is in a position of rest located, for example, between its open position and its closed position.

In the closed position, the free periphery of the valve 50 is separated from the walls of the channel 22 and from the lower side 12 of the substrate 6 by a play. For example, this play is larger than or equal to 0.1 or 1 μm. The free periphery of the valve 50 corresponds to the periphery of the valve 50 minus its anchored side.

More precisely, here, the free periphery of the valve 50 is formed by:
a horizontal upper side facing the lower side 12;
a horizontal lower side facing the bottom of the channel 22; and
a vertical distal side located opposite and parallel to the proximal side of the valve 50.

In this embodiment, in order to suppress almost completely leaks via this play, at least during operation, the channel 22 comprises a shoulder 54 against which the free periphery of the valve 50 directly bears mechanically when the latter is in its closed position. This shoulder almost completely obstructs the play when the valve 50 is in its closed position. The shoulder 54 is located upstream of the valve 50.

For example, the shoulder 54 is formed by two abutments 56 and 58. The abutments 56 and 58 are secured, with no degree of freedom, to the substrates 4 and 6, respectively.

Here, the abutment 56 has an “L” shape. The horizontal arm of the “L” extends parallel to the Y direction over the entire length of the bottom of the channel 22. The vertical arm of the “L” extends parallel to the Z direction along the vertical wall of the channel 22, facing the wall of the channel 22 to which the proximal side of the valve 50 is anchored. Here, the vertical arm of the “L” extends over at least 80% of the height of the channel 22.

In the closed position, the lower and distal sides of the valve 50 mechanically rest against the horizontal and vertical arms of the “L” of the abutment 56, respectively.

The abutment 58 extends parallel to the Y direction along the lower side 12. This abutment 58 sides the horizontal bar of the “L” of the abutment 56. Its length is larger than 70 or 80% of the width of the channel 22 in the Y direction. In the closed position, the upper side of the valve 50 rests against the abutment 58.

The channel 26 comprises an anti-return valve 60. In FIGS. 1 and 2, it is shown in its closed position. This valve 60 is produced in the same way as the valve 50.

In its closed position, the free periphery of the valve 60 bears directly against a shoulder 62 of the channel 26 located immediately upstream of this valve 60. The shoulder 62 is for example identical to the shoulder 54.

The pump 2 also comprises an assembly 64 for measuring the flow rate of the pumped fluid. This assembly is described in more detail with reference to FIG. 3.

The assembly 64 is connected to an electronic processing unit 65 able to calculate the flow rate from measurements taken by the assembly 64.

FIG. 3 shows the assembly 64 in more detail. This assembly 64 comprises:
the substrate 6;
a well 66 filled with a thermally insulating material; and
two temperature probes 68 and 69 and a heating electrical resistor 70, which are placed on the thermally insulating material.

In this description, the expression “thermally insulating material” is understood to mean a material the thermal conductivity of which at 20° C. is lower than 5 W·m⁻¹·K⁻¹, and preferably lower than 2 or 1 W·m⁻¹·K⁻¹.

The probe is the active component that is sensitive to temperature. In other words this is the component that allows the measurement to be carried out. In contrast, the probe does not necessarily comprise a control/processing component allowing the signals generated by the probe to be processed. This control/processing component may be placed elsewhere than on the well. Thus, when the probe is said to be placed on the thermally insulating material, this does not necessarily mean that the control/processing component allowing the probe signals to be processed is also placed on this thermally insulating material. Preferably, each probe is entirely and only placed on the thermally insulating material.

The well 66, filled with thermally insulating material, allows the probes 68 and 69 and the resistor 70 to be thermally insulated from the substrate 6. Here, this substrate 6 is made of a thermally conductive material. In this description, the expression “thermally conductive material” is understood to mean a material the thermal conductivity of which at 20° C. is higher than 50 W·m⁻¹·K⁻¹, and preferably higher than 100 or 150 W·m⁻¹·K⁻¹. For example, in this description, the substrate 6 comprises a layer made of silicon, inside of which most of the well 66 is dug.

Here, the well 66 is essentially parallelepipedal in shape. It is dug into the side 12 of the substrate 6. In addition, it is completely encircled, in the XY plane, by the substrate 6.

The depth of the well 66, measured from level with the side 12, is larger than 10 μm and typically larger than 50 or 100 μm. The depth of the well 66 is however smaller than the thickness of the substrate 6 in order to leave a band of the substrate 6 under the well 66. The thickness, in the Z direction, of this band under the well 66 is larger than 100 μm, and preferably larger than 200 or 500 μm.

The well 66 is completely filled with a thermally insulating material 72. For example, the material 72 is silicon oxide glass or borosilicate glass or a polymer.

The material 72 has an exterior side 74 that is flush with the side 12 of the substrate 6. Here, these sides 72 and 12 extend in the same plane to within plus or minus 0.5 μm, and preferably to within plus or minus 0.1 μm.

The thickness of the material 72 is here equal to the depth of the well 66. Thus, to improve the thermal insulation, the well 66 is preferably as deep as possible.

By way of illustration, the length in the X direction of the well 66 is larger than 50 μm and, preferably, larger than 100 or 200 μm. Its width in the Y direction is larger than 50 μm and, preferably, larger than 100 or 200 μm. Thus, the area of the side 74 is larger than 500 or 1000 μm².

The well 66 is dug into the substrate 6 in a location such that the side 74 makes direct contact with the fluid the flow rate of which must be measured. In this example, the side 74 opens onto the interior of the hole 20.

The probes 68 and 69 are able to convert a temperature variation into a measurable variation in an electrical property. For example, the probes 68 and 69 are thermistors or resistance thermometers. They are therefore essentially formed from a block of material the resistance of which varies as a function of temperature. For example, these resistors are bands made of a material chosen from the group containing silver, copper, nickel, gold, platinum, tungsten, titanium and aluminum, or even of silicon.

The probes 68 and 69 are entirely placed on the side 74 in order to be completely thermally insulated from the substrate by the material 72. Here, the probes 68 and 69 are placed one after the other in the flow direction F of the fluid. Each of these probes is electrically connected by a wired connection to the processing unit 65.

The heating electrical resistor 70 is placed directly on the side 74 between the probes 68 and 69 in the direction F. This resistor heats the fluid when commanded to do so by the unit 65. Preferably, the resistor 70 is entirely placed on the side 74 in order to limit the power consumption of the assembly 64. Here, the resistor 70 is supplied with power by the processing unit 65.

The probes 68 and 69 and the resistor 70 together form a flow rate sensor that delivers signals depending on the flow rate of the fluid pumped by the pump 2.

The processing unit 65 calculates the flow rate of the fluid from temperatures measured at the same time by the probes 68 and 69, respectively. This unit 65 therefore for example functions as described in the following B1 patent: US 2009/078040 or in the following B2 patent application: US 2006/000270. Alternatively, or at the same time, the unit 65 may also calculate the temperature of the pumped fluid from the measurements taken by the probes 68 and 69.

The operating mode of the pump may be deduced from the above explanation and, if necessary, from the explanation given in patent application WO 2011/133014 A1. The operating mode of the assembly 64 is explained in the above B1 and B2 patent applications and will therefore not be described here in further detail. However, it will be noted that the absence of a membrane allows the precision of the measurement of flow rate and temperature to be increased.

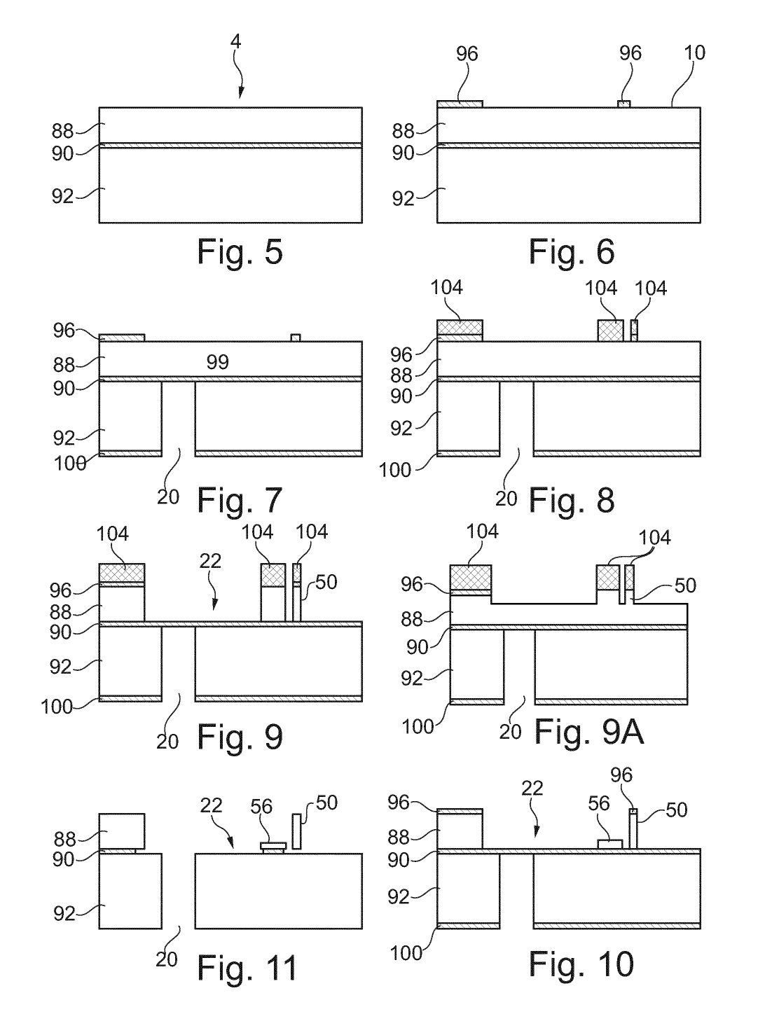

A process for fabricating the pump 2 will now be described with reference to the process in FIG. 4 and to the various illustrations in FIGS. 5 to 17. To simplify FIGS. 5 to 17, only the portion on the left of the plane 18 has been shown in each of these figures. In addition, the fabrication process will now be described for the particular case where the depth of the chamber 24 is equal to the depth of the channels 22 and 26.

The process in FIG. 4 comprises two phases 80 and 82 that may for the most part be carried out in parallel.

The phase 80 is a phase of fabrication of the substrate 4 whereas the phase 82 is a phase of fabrication of the substrate 6.

At the start of the phase 80, in a step 86, the substrate 4 is provided. Here, it is a question of a BSOI (bonded silicon-on-insulator) substrate. The substrate 4 comprises a layer 88 (FIG. 5) made of silicon on an electrically insulating layer 90 itself placed directly on a carrier 92. The layer 88 has a thickness comprised between 10 and 200 μm. The layer 90 has a thickness comprised between 0.5 and 2 μm. The carrier 92, which is intended to stiffen the substrate, has, for this purpose, a thickness larger than 500 μm or than 725 μm.

Next, in a step 94, an oxide layer is deposited on the upper side. For example, this deposition is carried out by plasma-enhanced chemical vapor deposition (PECVD). Next, a step of lithography then etching of this oxide layer is carried out to form a mask 96 (FIG. 6). The etching is for example reactive ion etching (RIE).

In a step 98, an oxide layer is deposited on the lower side of the substrate 4. For example, this deposit is produced using a PECVD process. Next, lithography followed by etching of this layer is carried out to form a mask 100 that defines the location of the hole 20 (FIG. 7). In the same step 98, the lower side of the substrate is then etched to form a first portion of the hole 20. This etching is for example carried out using a deep reactive ion etching (DRIE) process.

In a step 102, a lithography step is carried out in order to form a resist mask 104 (FIG. 8). This mask 104 defines the location of the valve 50, of the channel 22, of the chamber 24 and of the abutment 56.

In a step 106, the upper side is etched through the mask 104 (FIG. 9). For example, in FIG. 9 this etching is carried out using a DRIE process using the layer 90 as a stop layer. This etching allows the channel 22, the upper end of the hole 20, the valve 50 and the cavity of the chamber 24 to be formed.

In a step 108, the mask 104 is removed (FIG. 10).

Next, etching is carried out from the upper side using the mask 96. This etching is for example carried out using a DRIE process. This etching allows the abutment 56 to be formed.

In a step 110, the valve 50 is freed by implementing a wet or vapor phase HF etch (FIG. 11). This etching also allows the layer 100 to be removed and the hole 20 to be unblocked.

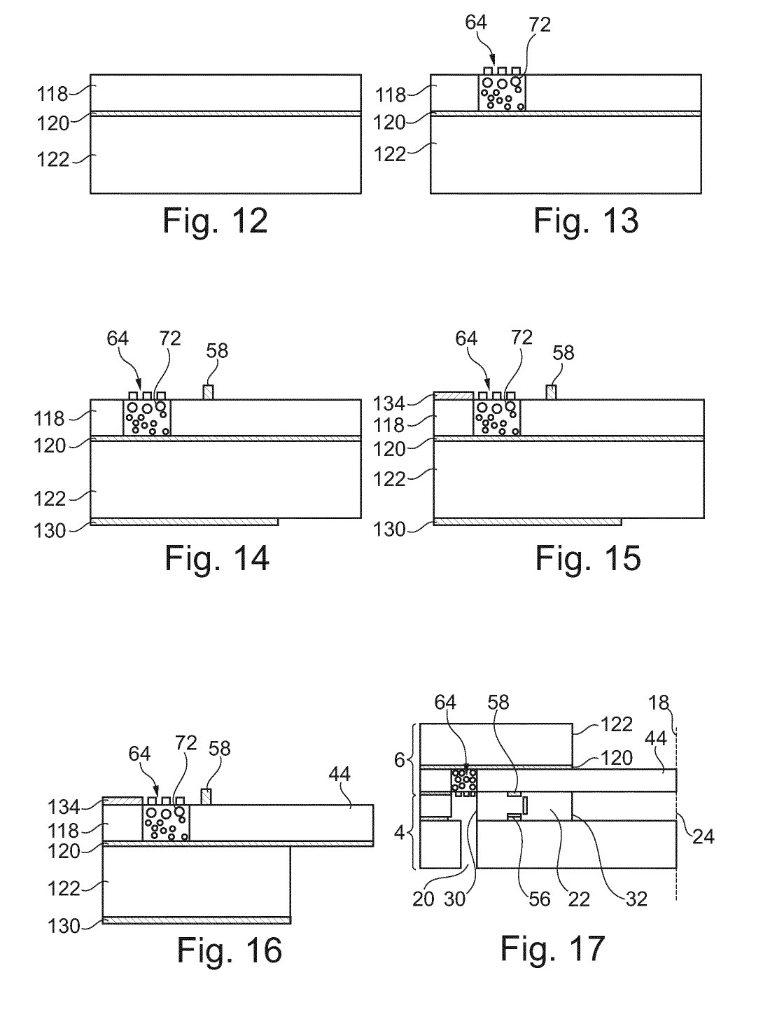

In parallel, at the start of the phase 82, in a step 116, the substrate 6 is provided (FIG. 12). This substrate is also a BSOI substrate for example. It comprises a layer 118 made of silicon, which layer is superposed on an electrically insulating layer 120 that is itself superposed on a carrier 122. The thicknesses of the layers 118, 120 and of the carrier 120 are for example comprised in the same ranges as those given for the substrate 4 provided in step 86.

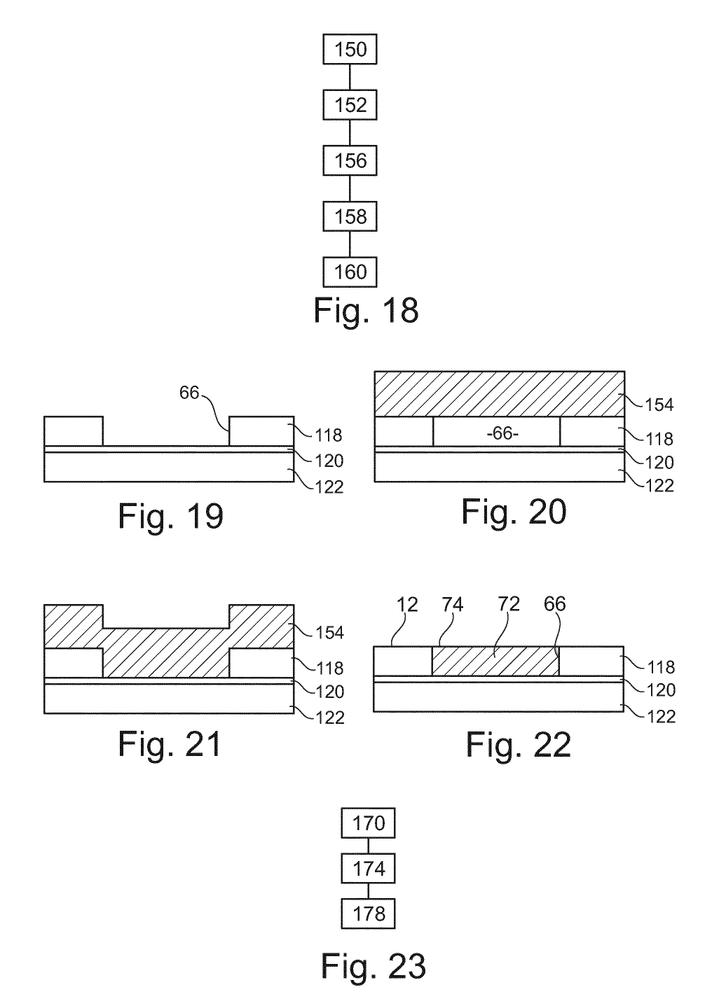

In a step 124, the measuring assembly 64 is produced (FIG. 13). In this step 124, the well 66, filled with the material 72, is formed in the substrate 6, then the probes 68, 69 and the resistor 70 are placed on the exterior side 74. Various embodiments of this step 124 are described in greater detail with reference to FIG. 18 et seq.

In a step 128, the abutment 58 (FIG. 14) is produced on a section of the side 12. Next, a mask 130 (FIG. 14) is deposited on the lower side of the carrier 122. To obtain this mask, an oxide layer is for example deposited using a PECVD process and then lithography and etching steps are carried out to form the mask 130. The etching is for example RIE etching.

In a step 132, a metal layer 134 (FIG. 15) is deposited on the layer 118. For example, it is deposited using a PVD (physical vapor deposition) process. The metal layer is then subjected to a lithography step followed by a step of etching this metal layer to form the metal layer 134 making up most of the lower side 12 of the substrate 6.

Lastly, in a step 136, the membrane 44 is formed by etching the lower side of the substrate 6 through the mask 130 (FIG. 16). During this etching, the layer 120 is used as a stop layer.

Next, once the substrates 4 and 6 have been fabricated, in a step 140, the upper side 10 of the substrate 4 is bonded to the lower side 12 of the substrate 6 (FIG. 17). The pump 2 is thus obtained.

FIG. 9A shows a variant of the fabrication process in FIG. 4. This variant is identical to the process in FIG. 4 except that, in the step 106, etching is carried out that allows the abutment 56, and the channel 22, the upper end of the hole 20, the valve 50 and the cavity of the chamber 24 to be partially formed. This etching is typically carried out to a depth ranging from 1 to 5 μm (FIG. 9A). After step 108 and before step 110, the upper side is etched again using the mask 96. This etching is for example carried out using a DRIE process. This etching makes it possible to finish forming the abutment 56, the channel 22, the upper end of the hole 20, the valve 50 and the cavity of the chamber 24.

FIG. 18 shows a first process for fabricating the assembly 64. In a step 150, the well 66 is dug, from the side 12, into the layer 118 of the substrate 6, by lithography and etching (FIG. 19). The depth of the well 66 dug is larger than 10 μm and, preferably, larger than 100 μm.

Next, in a step 152, a rigid sheet 154 made of glass is bonded to the side 12 of the layer 118. This sheet covers the well 66 (FIG. 20). The glass sheet is for example made of borosilicate glass or silicon oxide glass.

Next, in a melting step 156, a heat treatment is applied to the sheet 154. During this heat treatment, the melting point of the sheet 154 is exceeded so that the sheet melts and fills the well 66 (FIG. 21).

In a step 158, the side of the substrate is thinned then polished so as to reexpose the side of the layer 118 and to planarize it. Preferably, the thinning is carried out by grinding. It may also be carried out chemically. The polishing is for example chemical-mechanical polishing. At the end of this step 158 a well 66 filled with material 72 is obtained.

Lastly, in a step 160, the probes 68 and 69 and the resistor 70 are formed on the side 74. For example, the probes in the resistor are fabricated by successively depositing and etching layers on the side 74.

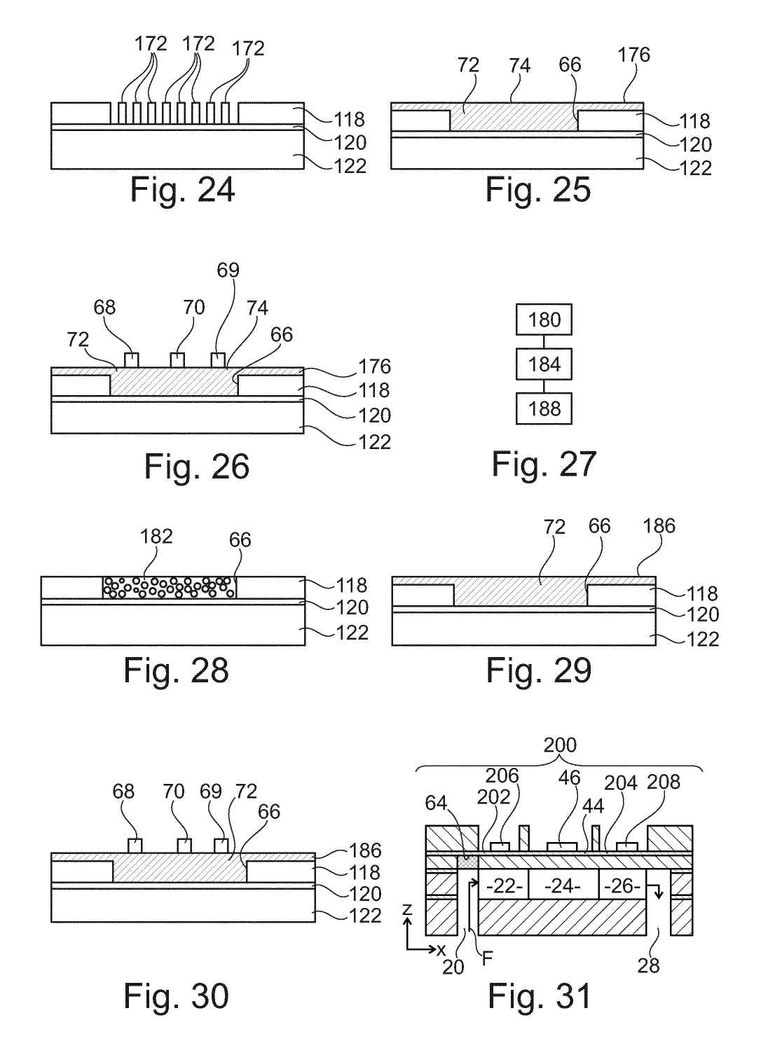

A second process for fabricating the assembly 64 will now be described with reference to the process in FIG. 23 and to FIGS. 24 to 26. Fabrication of the well in this process is similar to that described in the following article A1: Chunbo Zhang and Khalil Najafi, “Fabrication of thick silicon dioxide layers for thermal isolation”, J. Micromechanics and Microengineering 14 (2004) pages 769-774.

Thus, below, the steps used to fabricate the well are not described in detail.

In a step 170, trenches are dug in the layer 118 so as to bound vertical pillars 172 (FIG. 24) extending from the layer 120 as far as level with the exterior side of the layer 118. The height of these pillars is typically larger than 10 μm and, preferably, larger than 50 or 100 μm. The height of the pillars is in contrast generally smaller than 200 μm. The width of the pillars 172 in the X and Y directions is about equal to the width of the trenches in the same directions. For example, the width of the pillars is about 10 μm.

Next, in a step 174, a heat treatment at between 1100 and 1200° is applied in order to oxidize the pillars 172. This oxidation step is carried out so as to grow a layer of silicon oxide that is about 10 μm thick. This layer 174 of silicon oxide then completely fills the trenches that separate the pillars 172. In addition, this thermal oxidation completely converts the pillars 172 of silicon into silicon oxide. Thus, at the end of step 174, a well 66 filled with silicon oxide is obtained.

Lastly, in a step 178, the probes 68, 69 and the resistor 70 are formed on the side 74 (FIG. 26) of the thermally insulating material 74. This step 178 is for example identical to the step 160.

A third process for fabricating the assembly 64 will now be described with reference to the process in FIG. 27 and to FIGS. 28 to 30. In this process, fabrication of the well is similar to that described in the following article A2: P. Maccagnani, “Thick oxidized porous silicon layer as thermo-insulating material for high temperature operating thin and thick film gas sensors”, Transducers, 1997.

In a step 180, a well 66 filled with porous silicon 182 is formed. For example, to do this, anodization or dopant implantation is used. More details on this step are given in article A2. The depth of the well is larger than 10 μm and, generally, smaller than 200 μm.

Next, in a step 184, the silicon is oxidized by applying, for example, a heat treatment. This oxidation causes an oxide layer 186 to appear the thickness of which is typically smaller than 5 μm. Given the porous structure of the porous silicon 182, almost all of the porous silicon 182 is oxidized in this step. In addition, the pores of the porous silicon fill with silicon oxide. At the end of this step 184, a well 66 filled with silicon oxide is obtained. Thus, preferably, step 184 is carried out until more than 90% or 95% or 99% or all of the porous silicon 182 has been oxidized. However, as a variant, it is also possible to oxidize only some of the porous silicon 182. For example, only a surface layer of at least 10 μm in thickness of the porous silicon is completely oxidized.

Lastly, in step 188, the probes 68 and 69 and the resistor 70 are formed, for example as described with reference to step 160.

FIG. 31 shows a pump 200. The pump 200 is identical to the pump 2 except that the valves 50, 60 have been replaced by membranes 202 and 204, respectively. The shoulders 54, 62 have been omitted. In addition, in FIG. 31, the depth of the chamber 24 is equal to the depth of the channels 22 and 24. The membranes 22 and 24 form upper walls of the channels 22 and 24, respectively. They are produced and function just like the membrane 44. The membranes 202 and 204 are moved between their suction and expulsion positions by actuators 206 and 208, respectively. These actuators 206 and 208 are for example identical to the actuator 46.

During operation of the pump 200, the actuators 206, 44 and 208 are actuated in succession in this order so as to move a quantity of fluid from the channel 22 into the chamber 24 then from the chamber 24 into the channel 26. Once the membrane 204 has returned to its rest position, the membrane 202 is actuated again in order to expel a new quantity of fluid into the chamber 24. The pump 200 does not require any anti-return valves in order to operate. A process for fabricating this pump 200 may easily be deduced from the explanation given regarding fabrication of the pump 2.

Many other embodiments are possible. For example, other thermally conductive materials may be used for the substrates. Thus, the thermally conductive material may be gallium or gallium nitrate. The thermally conductive material may be homogenous or heterogeneous. It is considered to be heterogeneous when it is formed by an assembly of a plurality of different homogenous materials. This is the case of the substrate 6 described with reference to the process in FIG. 4. Specifically, in this particular case, the substrate 6 was described as being formed from an assembly of various layers of thermally conductive materials. As a variant, the substrate is a homogenous material made entirely of the same thermally conductive material, such as silicon for example.

Similarly, other thermally insulating materials may be used to fill the well. For example, the material may be a polymer, such as a polymer filled with graphite in order to limit mechanical strain due to differences in the expansion coefficients of the substrate and polymer. The thermally insulating material may also be porous silicon directly. Just like the material of the substrate, the thermally insulating material may be homogenous or heterogeneous. It is heterogeneous when the thermally insulating material is formed by an assembly of a plurality of different thermally insulating materials. For example, it may be formed by an assembly of a plurality of layers of various thermally insulating materials.

The substrate 4 may be bonded to the substrate 6 using various methods such as:
molecular bonding, i.e. without addition of material;
metal eutectic or thermocompression bonding;
bonding with a polymer adhesive; and/or
glass frit bonding.

The substrate 6 is not necessarily added to the substrate 4. It may instead be deposited on the substrate 4 in the form of a layer itself deposited on a sacrificial layer filling the various channels and the cavity of the substrate 4. Then, after the substrate 6 has been deposited, the sacrificial layer is removed so as to free the channels and the chamber of the pump.

The temperature probes and the heating resistor may be fabricated independently of the well filled with thermally insulating material, then subsequently added to the exterior side 74.

The measuring assembly described above may be used in other pumps. For example, it may be used in the pump described in the above B1 patent application. It 40 may also be used in pumps devoid of anti-return valves, such as the pump 200. The assembly may also be used in other systems that are not necessarily pumps. For example, the assembly may be used simply to measure the flow rate flowing through a microfluidic duct of a device. The assembly 64 may also be used to measure only the temperature of the fluid. In this case, the resistor 70 may be omitted and a single temperature probe may suffice.

The pump may also be produced by joining more than two substrates.

The measuring assembly may be placed elsewhere in the pump. For example, the measuring assembly may be placed so that the temperature probes and the side 74 are flush in either one of the channels of the pump or in the chamber 24. The measuring assembly may also be produced in the substrate 4 rather than in the substrate 6.

In another embodiment, the channels and the cavity are not dug but formed by depositing successively structured layers one on top of the other.

As a variant, the suction position of the membrane 42 or, alternatively, its expulsion position may be the same as its rest position.

The cavity may have the same cross section as the channels 22 and 26. In this case, the cavity is distinguishable from the channels only insofar as it is covered by the movable membrane, which is not the case for the channels.

The pump 2 may also comprise a plurality of intake channels and a plurality of discharge channels fluidically connected to the same chamber 24. In this case, each of these intake and discharge channels comprises its own anti-return valve.

In another embodiment, the movement of each valve is actuated by an electrical or thermal actuator. For example, the actuator is based on a similar principle to that employed to move the membrane 44.

In a simplified embodiment, the shoulders are omitted. Specifically, if the play between the free periphery of the valve and the walls of the channel is sufficiently small, a negligible leakage of liquid is obtained even in the absence of the shoulders.

1-15. (canceled)

16. A pump comprising:
a first substrate extending essentially in a plane, the substrate having a side;
a cavity formed in the side of the first substrate;
intake and discharge channels for admitting and discharging a fluid, respectively, said channels being formed in the side of the first substrate; and
a second substrate having a side joined to the side of the first substrate, the side closing the channels in order to form tubes inside of which the pumped fluid is able to flow, the second substrate also comprising at least one membrane closing the cavity to form a chamber that is leak-tight to the fluid, the membrane being deformable:
from a suction position to an expulsion position in order to expel the fluid out of the chamber via the discharge channel, and
from the expulsion position to the suction position in order to suck the fluid into the chamber via the intake channel;
an actuator capable of converting the energy that it receives into a movement of the membrane between its suction and expulsion positions, and—an assembly for measuring the temperature or flow rate of the fluid, the assembly comprising:
inside one of the substrates, a well entirely filled with a thermally insulating solid material having an exterior side flush with the interior of the tube or of the chamber, and
a temperature probe placed, above the well, on the exterior side of the insulating material in order to insulate thermally the probe from the substrate.

17. The pump as claimed in claim 16, in which the pump furthermore comprises first and second anti-return valves housed inside the intake and discharge channels, respectively.

18. The pump as claimed in claim 16, in which the thickness of the thermally insulating material in the well is larger than 10 μm and strictly smaller than the thickness of the substrate so as to preserve under the well a thickness of at least 100 μm of substrate.

19. The pump as claimed in claim 16, in which the side of the substrate containing the well completely encircles the well thus forming a periphery of the well, and the side of the other substrate is joined to the substrate on the periphery of the well.

20. The pump as claimed in claim 16, in which the thickness of the thermally insulating material contained in the well is larger than 100 μm.

21. The pump as claimed in claim 16, in which the substrate containing the well comprises a layer of at least 10 μm thickness made of a thermally conductive material, and the well is essentially located inside this layer, the thermally conductive material being defined as being a material the thermal conductivity of which at 20° C. is higher than 50 W·m−1·K−1.

22. The pump as claimed in claim 21, in which the layer is made of silicon.

23. The pump as claimed in claim 16, in which the thermally insulating material is a material having a thermal conductivity at 20° C. lower than 5 W·m−1·K−1.

24. A process for fabricating a pump as claimed in claim 16, the process comprising:
providing a first substrate extending essentially in a plane, the first substrate having a side;
forming a cavity and intake and discharge channels in the side of the first substrate; and
joining to the side of the first substrate a second substrate having a side closing the channels so as to form tubes inside of which the pumped fluid is able to flow, the second substrate also comprising at least one membrane closing the cavity in order to form a chamber that is leak-tight to the fluid, this membrane being deformable:
from a suction position to an expulsion position in order to expel the fluid out of the chamber via the discharge channel, and
from the expulsion position to the suction position in order to suck the fluid into the chamber via the intake channel;
providing an actuator capable of converting the energy that it receives into a movement of the membrane between its suction and expulsion positions, and
forming, inside one of the substrates, a well entirely filled with a thermally insulating solid material having an exterior side flush with the interior of the tube or of the chamber; and
forming at least one temperature probe entirely placed on the exterior side of the thermally insulating material in order to insulate thermally the probe from the substrate and obtain an assembly for measuring the temperature or flow rate of the fluid.

25. The fabrication process as claimed in claim 24, in which the thickness of the thermally insulating material filling the well is larger than 10 μm and strictly smaller than the thickness of the substrate so as to preserve under the well a thickness of at least 100 μm of substrate.

26. The process as claimed in claim 24, in which, forming the well in the substrate comprises:
producing a cavity in the side of this substrate;
adding a rigid sheet of thermally insulating material to the side of the substrate, the sheet thus covering the cavity;
applying a heat treatment at a temperature above the melting point of the sheet so that the latter melts into the cavity; and
thinning the melted sheet until the side of the substrate is exposed.

27. The process as claimed in claim 26, in which the thermally insulating material of the sheet is a borosilicate glass or a silicon oxide glass.

28. The process as claimed in claim 24, in which forming the well in the substrate comprises:
providing a substrate comprising a layer made of an oxidizable material, the oxide of this material being a thermally insulating material;
producing trenches in the side of this substrate of at least 10 μm depth, the trenches bounding pillars in the layer made of oxidizable material of the substrate; and
oxidizing the pillars right through their thickness, so as to form an oxide that fills the trenches, the oxidized pillars and the oxide-filled trenches then forming the well filled with thermally insulating material.

29. The process as claimed in claim 24, in which forming the well in the substrate comprises:
providing a substrate comprising a layer made of an oxidizable material, the oxide of this material being a thermally insulating material; and
forming a well of at least 10 μm depth filled with the material of the layer but made porous.

30. The process as claimed in claim 29, in which the process furthermore comprises a step of oxidizing all or some of the porous material so as to fill the pores of the porous material with oxide and so as to oxidize at least partially the walls of the porous material in order to obtain the well filled with thermally insulating material.
